(19) United States
(12) Patent Application Publication
(10) Pub. No.: US 2024/0278308 A1
(43) Pub. Date: Aug. 22, 2024

(54) APPARATUS FOR MANUFACTURING LAMINATED IRON CORE AND BACK-PRESSURE JIG

(71) Applicant: TOYOTA BOSHOKU KABUSHIKI KAISHA, Aichi-ken (JP)

(72) Inventor: Yuka NAKAI, Kariya-shi (JP)

(73) Assignee: TOYOTA BOSHOKU KABUSHIKI KAISHA, Aichi-ken (JP)

(21) Appl. No.: 18/438,713

(22) Filed: Feb. 12, 2024

(30) Foreign Application Priority Data
Feb. 20, 2023 (JP) 2023-024531

(51) Int. Cl. B21D 28/34; H01F 41/02

(52) U.S. Cl. CPC B21D 28/34; H01F 41/0233

(57) ABSTRACT

An apparatus for manufacturing a laminated iron core includes a die, a punch that is configured to cooperate with the die to punch out iron core pieces from a magnetic steel sheet, a retaining ring that includes an inner circumferential surface configured to hold outer circumferential surfaces of the iron core pieces, and a back-pressure jig. The back-pressure jig is configured to support a lower surface of the iron core pieces so as to apply, to the iron core pieces, a back pressure that is an upward pressure when the punch pushes the iron core pieces downward. The back-pressure jig includes a holding portion slidably held by the inner circumferential surface of the retaining ring, and a support portion that is coupled to the holding portion and configured to support the lower surface of the iron core pieces.

### BACKGROUND

### 1. Field

The present disclosure relates to an apparatus for manufacturing a laminated iron core and to a back-pressure jig.

### 2. Description of Related Art

International Publication No. WO2015/132814 discloses a progressive die apparatus. The progressive die apparatus is equipped with a punch and die for punching out iron core sheets from a band-shaped thin steel sheet that is transferred intermittently. The apparatus further includes a retaining ring, which is arranged below the die and holds the outer circumferential surfaces of the iron core sheets, and a back-pressure device, which applies an upward pressure, or a back pressure, to the iron core sheets held by the retaining ring. The back-pressure device includes a receiving table, a support unit, an elevating motor, and a controller. The receiving table is provided inside the retaining ring to be lifted and lowered. The iron core sheets are sequentially placed on the receiving table. The support unit supports the receiving table. The elevating motor lifts or lowers the receiving table with the support unit in between. The controller controls rotation of the elevating motor. Through the control of the elevating motor by the controller, the receiving table is lowered to a position at which iron core sheets are punched. Accordingly, the punch, having punched out an iron core sheet, and the receiving table apply back pressure to the iron core sheets placed on the receiving table.

The apparatus of the above-described publication requires the elevating motor and the controller and has a complicated structure. Thus, there is a need for a back-pressure device having a simple structure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an apparatus for manufacturing a laminated iron core includes a die, a punch that is configured to be lifted and lowered in an area above the die and to cooperate with the die to punch out iron core pieces from a magnetic steel sheet, and a retaining ring that is disposed below the die and includes an inner circumferential surface configured to hold outer circumferential surfaces of the iron core pieces. The apparatus is configured to manufacture the laminated iron core by laminating the iron core pieces in the retaining ring. The apparatus further comprises a back-pressure jig attached to an inner circumferential surface of the retaining ring. The back-pressure jig is configured to support a lower surface of the iron core pieces so as to apply, to the iron core pieces, a back pressure that is an upward pressure when the punch pushes the iron core pieces downward. The back-pressure jig includes a holding portion slidably held by the inner circumferential surface of the retaining ring, and a support portion that is coupled to the holding portion and configured to support the lower surface of the iron core pieces.

In another general aspect, a back-pressure jig employed in an apparatus for manufacturing a laminated iron core is provided. The apparatus includes a die, a punch that is configured to be lifted and lowered in an area above the die and to cooperate with the die to punch out iron core pieces from a magnetic steel sheet, and a retaining ring that is disposed below the die and includes an inner circumferential surface configured to hold outer circumferential surfaces of the iron core pieces. The apparatus is configured to manufacture the laminated iron core by laminating the iron core pieces in the retaining ring. The back-pressure jig is attached to an inner circumferential surface of the retaining ring and configured to support a lower surface of the iron core pieces so as to apply, to the iron core pieces, a back pressure that is an upward pressure when the punch pushes the iron core pieces downward. The back-pressure jig includes a holding portion slidably held by the inner circumferential surface of the retaining ring, and a support portion that is coupled to the holding portion and configured to support the lower surface of the iron core pieces.

Other features and aspects will be apparent from the following detailed description, the drawings, and the claims.

### BRIEF DESCRIPTION OF THE DRAWINGS

FIG. 1 is a cross-sectional view showing an apparatus for manufacturing a laminated iron core including a back-pressure jig according to one embodiment.

FIG. 2 is a bottom view of the back-pressure jig shown in FIG. 1.

FIG. 3 is a cross-sectional view taken along line 3-3 of FIG. 2.

FIG. 4 is a cross-sectional view illustrating a state in which the back-pressure jig shown in FIG. 1 is inserted in a retaining ring.

FIG. 5 is a cross-sectional view illustrating a state immediately after the punch shown in FIG. 1 has punched out an iron core piece.

FIG. 6 is a cross-sectional view illustrating a state in which the back-pressure jig shown in FIG. 1 falls off from the retaining ring and is received by a conveying device.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

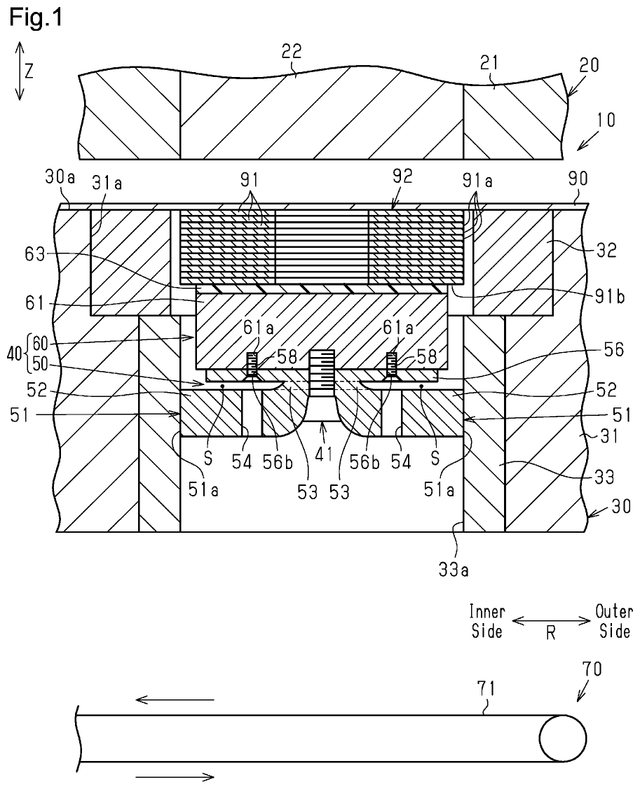

An apparatus for manufacturing a laminated iron core and a back-pressure jig according to one embodiment will now be described with reference to FIGS. 1 to 6. For illustrative purposes, some parts of the structures in the drawings are exaggerated or simplified, and the dimensional ratios of the structures may be different from the actual ratios.

First, an apparatus for manufacturing a laminated iron core (hereinafter, referred to as a manufacturing apparatus 10) will be described.

As shown in FIG. 1, the manufacturing apparatus 10 includes a lower die assembly 30, an upper die assembly 20, a back-pressure jig 40, and a conveying device 70. The upper die assembly 20 is located above the lower die assembly 30 and is movable vertically with respect to the lower die assembly 30.

### Upper Die Assembly 20

The upper die assembly 20 includes a substantially columnar punch 22 and a punch holder 21, which accommodates the punch 22. The punch 22 is configured to be lifted and lowered in an area above a die 32, which will be discussed below, and cooperates with the die 32 to punch out iron core pieces 91 from a magnetic steel sheet 90.

### Lower Die Assembly 30

The lower die assembly 30 includes a die holder 31, a die 32, and a retaining ring 33. The die holder 31 includes a through-hole 31a, which opens in a support surface 30a, which corresponds to the upper surface. The die 32 and the retaining ring 33, each having a cylindrical shape, are coaxially arranged in the through-hole 31a.

The inner diameter of the die 32 is slightly larger than the diameter of the punch 22.

The retaining ring 33 is arranged below the die 32. The retaining ring 33 includes an inner circumferential surface 33a, which presses and holds outer circumferential surfaces 91a of the iron core pieces 91. The inner diameter of the retaining ring 33 is slightly smaller than the inner diameter of the die 32.

### Back-Pressure Jig 40

As shown in FIG. 5, the back-pressure jig 40 is attached to the inner circumferential surface 33a of the retaining ring 33 and supports a lower surface 91b of the iron core pieces 91 so as to apply, to the iron core pieces 91, a back pressure that is an upward pressure when the punch 22 pushes the iron core pieces 91 downward.

In the following description, the radial direction and the circumferential direction of the retaining ring 33 will simply be referred to as a radial direction R and a circumferential direction C. The radially inner side and the radially outer side in the radial direction R will simply be referred to as a radially inner side and a radially outer side, respectively.

As shown in FIG. 1, the back-pressure jig 40 includes a holding portion 50 slidably held by the inner circumferential surface 33a of the retaining ring 33, and a support portion 60 that is coupled to the holding portion 50 and supports the lower surface 91b of the iron core pieces 91.

As shown in FIGS. 1 and 3, the support portion 60 includes a base 61 and a contact portion 63, which is fixed to the upper surface of the base 61. The base 61 is columnar and is made of metal. The contact portion 63 is in contact with the lower surface 91b of the iron core pieces 91. The contact portion 63 has the shape of a disc and covers the entire upper surface of the base 61 and is made of a plastic. The contact portion 63 of the present embodiment is made of, for example, urethane resin. The diameter of the support portion 60 is smaller than the inner diameter of the retaining ring 33.

As shown in FIGS. 1 to 3, the holding portion 50 includes a fixed portion 56, pressing portions 51, and a taper bolt 41.

The fixed portion 56 has the shape of a disc and is fixed to the lower surface of the support portion 60. The fixed portion 56 includes four bolt holes 56b arranged at equal intervals in the circumferential direction C. The fixed portion 56 is fixed to the base 61 by inserting bolts 58 into the bolt holes 56b from below and threading the bolts 58 into internal thread holes 61a, which open in the lower surface of the base 61 of the support portion 60.

The fixed portion 56 includes a circular hole 56a extending in a vertical direction Z through a center section.

The pressing portions 51 are arranged side by side in the circumferential direction C and each include a radially outer surface 51a capable of pressing the inner circumferential surface 33a of the retaining ring 33.

The number of the pressing portions 51 is eight in the present embodiment.

The radially outer surfaces 51a of the eight pressing portions 51 are located on the same circumference.

The pressing portions 51 are located below the fixed portion 56 and spaced apart from each other in the circumferential direction C. Each pressing portion 51 includes a substantially sectoral pressing portion main body 52 and a substantially sectoral coupling portion 53. The coupling portion 53 couples the radially inner end of the pressing portion main body 52 and the fixed portion 56 to each other. Thus, a gap S, which allows for displacement of each pressing portion main body 52, exists between the upper surface of the pressing portion main body 52 and the lower surface of the fixed portion 56. The radially outer surface 51a of each pressing portion main body 52 is located on the radially outer side of the outer circumferential surface of the support portion 60.

Four of the eight pressing portion main bodies 52 each include a through-hole 54, which extends in the vertical direction Z. The through-holes 54 are used to insert the bolts 58 and a tool for fastening the bolts 58 when inserting the bolts 58 into the internal thread holes 61a.

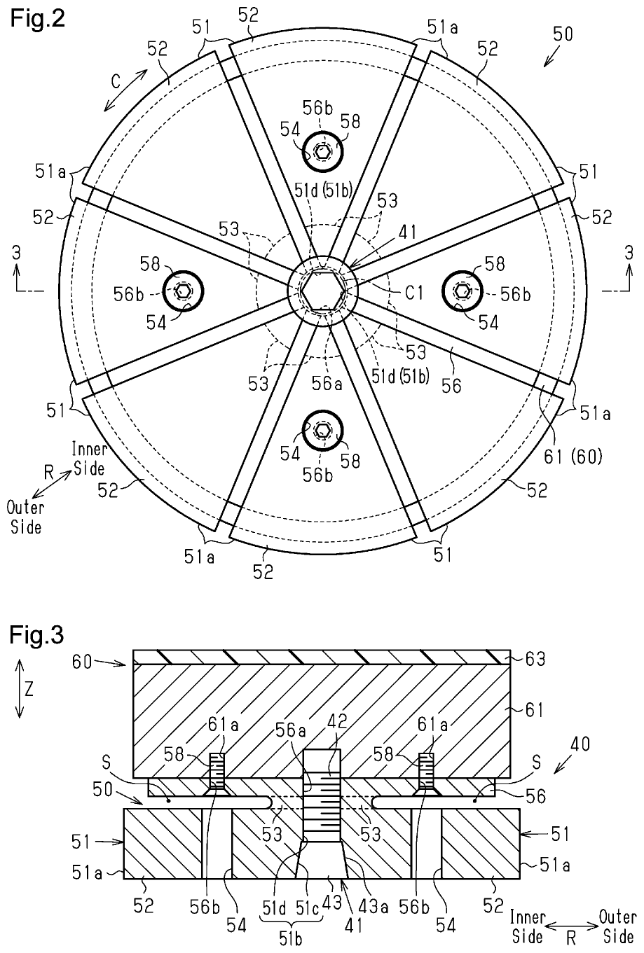

As shown in FIG. 2, the radially inner surfaces 51b of the pressing portion main bodies 52 and the coupling portions 53 are located on the same circumference.

As shown in FIG. 3, the radially inner surface 51b of each pressing portion main body 52 includes a straight section 51d, which extends in the vertical direction Z, and an inclined section 51c, which is adjacent to and located below the straight section 51d. The inclined section 51c is inclined such that the inclined section 51c is shifted radially outward as it extends downward.

The straight sections 51d are located on the circumference of an imaginary circle C1 that has the same diameter as the inner diameter of the circular hole 56a (see FIG. 2).

Internal threads (not shown) are formed on the radially inner surfaces 51b of the pressing portion main bodies 52.

The taper bolt 41 is threaded from below into the space surrounded by the radially inner surfaces 51b of the pressing portion main bodies 52. The taper bolt 41 includes an external thread portion 42 extending in the vertical direction Z and a head 43 coupled to the proximal end of the external thread portion 42. The head 43 has an inclined surface so as to taper toward the distal end, that is, toward the upper end, of the taper bolt 41. When the taper bolt 41 is threaded to the radially inner surfaces 51b of the pressing portion main bodies 52, the pressing portion main bodies 52 are pushed radially outward by the outer circumferential surface 43a of the head 43 as the head 43 progresses along the straight sections 51d. This displaces the radially outer surfaces 51a of the pressing portions 51 radially outward.

Thus, the radially inner surfaces 51b of the pressing portion main bodies 52 and the taper bolt 41 are configured to change the positions of the radially outer surfaces 51a of the pressing portions 51 in the radial direction R. In the present embodiment, the radially inner surfaces 51b of the pressing portion main bodies 52 and the taper bolt 41 form a changing unit.

### Conveying Device 70

As shown in FIG. 1, the conveying device 70 is located below the retaining ring 33 to receive and convey a laminated iron core 92 falling from the retaining ring 33. The conveying device 70 is a belt conveyor that includes an endless belt 71.

Operation of the present embodiment will now be described.

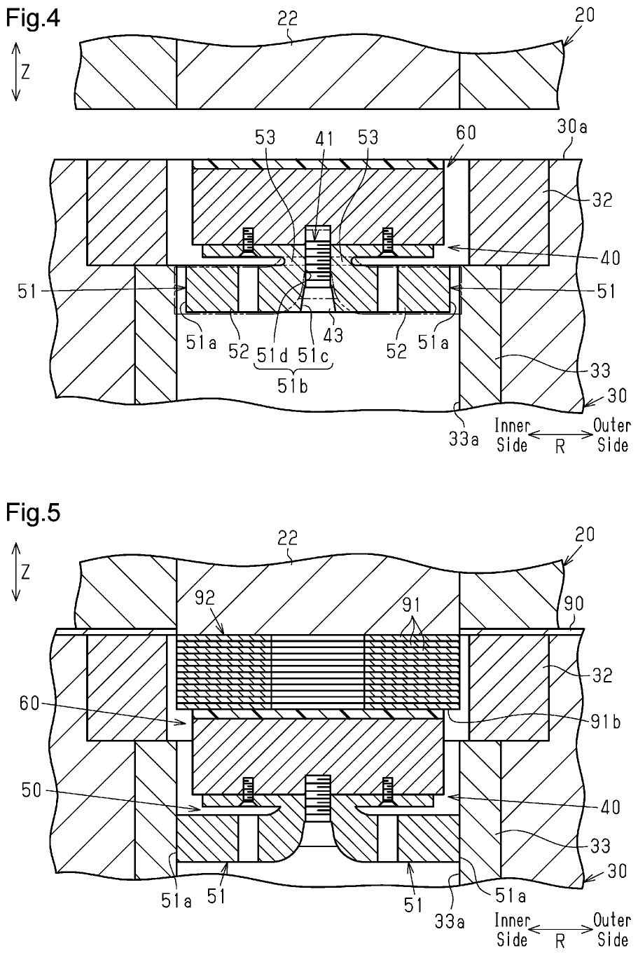

First, as shown in FIG. 4, the back-pressure jig 40 is inserted into the retaining ring 33 from below with the support portion 60 facing upward. As indicated by the long-dash double-short-dash line in FIG. 4, the back-pressure jig 40 is positioned at an initial position on the upper surface of the support portion 60, which will be discussed below. In this state, the taper bolt 41 is threaded into the space surrounded by the radially inner surfaces 51b of the pressing portion main bodies 52. This moves the radially outer surfaces 51a of the pressing portion main bodies 52 radially outward. Accordingly, the holding portion 50 is held by and attached to the inner circumferential surface 33a of the retaining ring 33.

The initial position is a position flush with the support surface 30a or a position below the support surface 30a by an amount corresponding to the thickness of a few iron core pieces 91.

As shown in FIG. 5, when an iron core piece 91 is punched out of the magnetic steel sheet 90, that iron core piece 91 is pushed downward by the punch 22. At this time, the support portion 60 of the back-pressure jig 40 applies, to the laminated iron core 92, a back pressure, which is upward pressure, so that the iron core pieces 91, which are stacked vertically, joined to each other through press-fitting of recesses and protrusions (neither is shown). When the support portion 60 is pushed downward by the iron core pieces 91, the holding portion 50 is moved downward while sliding on the inner circumferential surface 33a of the retaining ring 33.

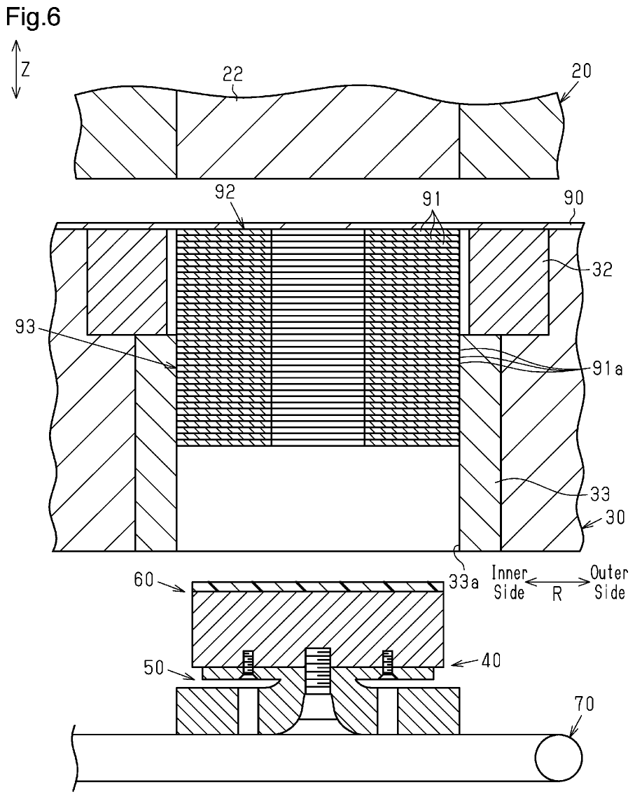

When the holding portion 50 moves downward to a position below the retaining ring 33 as shown in FIG. 6, the back-pressure jig 40 falls from the retaining ring 33 under its own weight. After the back-pressure jig 40 falls down, a laminated body 93 of the iron core pieces 91, which is held by the inner circumferential surface 33a of the retaining ring 33, applies back pressure to the iron core piece 91 above the laminated body 93 from below so that this iron core piece 91 is joined to the laminated body 93.

The present embodiment has the following advantages.

(1) The back-pressure jig 40 includes the holding portion 50 and the support portion 60. The holding portion 50 is slidably held by the inner circumferential surface 33a of the retaining ring 33. The support portion 60 is coupled to the holding portion 50 and supports the lower surface 91b of the iron core pieces 91.

This configuration operates in the above-described manner and thus allows back pressure to be applied to the laminated body 93 of the iron core pieces 91 without using any force.

(2) The manufacturing apparatus 10 includes the conveying device 70, which is located below the retaining ring 33 to receive and convey the laminated iron core 92 that falls from the retaining ring 33.

With this structure, the laminated iron core 92, which has falls from the retaining ring 33, is received and conveyed by the conveying device 70. This allows the laminated iron core 92 to be readily removed from the position below the retaining ring 33.

(3) The holding portion 50 includes the pressing portions 51, which are arranged side by side in the circumferential direction C and each include the radially outer surface 51a capable of pressing the inner circumferential surface 33a of the retaining ring 33. The holding portion 50 also includes the taper bolt 41, which is configured to change the positions of the radially outer surfaces 51a of the pressing portions 51 in the radial direction R of the retaining ring 33.

This configuration allows the taper bolt 41 to change the positions of the radially outer surfaces 51a of the pressing portions 51 in the radial direction R of the retaining ring 33. Thus, the sliding resistance of the pressing portions 51 against the inner circumferential surface 33a of the retaining ring 33, that is, the magnitude of the back pressure applied to the iron core pieces 91, can be readily adjusted.

(4) The support portion 60 includes the plastic contact portion 63, which is in contact with the lower surface 91b of the iron core pieces 91.

This configuration prevents the iron core pieces 91 from being damaged by contact with the support portion 60.

### Modifications

The above-described embodiment may be modified as follows. The above-described embodiment and the following modifications can be combined as long as the combined modifications remain technically consistent with each other.

In the above-described embodiment, the contact portion 63 is made of a plastic. Instead, the entire support portion 60 may be made of a plastic. Alternatively, the support portion 60 may be entirely made of metal.

For example, the pressing portion main bodies 52 may be formed separately from the fixed portion 56. Each pressing portion main body 52 may include an elongated hole that extends in the radial direction R to allow the pressing portion main body 52 to be fixed to the fixed portion 56 using the elongated hole. This allows the position at which the pressing portion main body 52 is coupled to the fixed portion 56 to be changed in the radial direction R. Even in this case, the position of the radially outer surface 51a of each pressing portion 51 can be changed. In this case, the coupling portions 53 may be omitted.

In the above-described embodiment, the conveying device 70 removes the back-pressure jig 40 and the laminated iron core 92 from below the retaining ring 33. Instead, for example, a push-out mechanism may be used to remove the back-pressure jig 40 and the laminated iron core 92 from below the retaining ring 33.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An apparatus for manufacturing a laminated iron core, the apparatus comprising:
a die;
a punch that is configured to be lifted and lowered in an area above the die and to cooperate with the die to punch out iron core pieces from a magnetic steel sheet; and
a retaining ring that is disposed below the die and includes an inner circumferential surface configured to hold outer circumferential surfaces of the iron core pieces, wherein
the apparatus is configured to manufacture the laminated iron core by laminating the iron core pieces in the retaining ring,
the apparatus further comprises a back-pressure jig attached to an inner circumferential surface of the retaining ring, the back-pressure jig being configured to support a lower surface of the iron core pieces so as to apply, to the iron core pieces, a back pressure that is an upward pressure when the punch pushes the iron core pieces downward, and
the back-pressure jig includes:
a holding portion slidably held by the inner circumferential surface of the retaining ring; and
a support portion that is coupled to the holding portion and configured to support the lower surface of the iron core pieces.

2. The apparatus for manufacturing the laminated iron core according to claim 1, further comprising a conveying device located below the retaining ring, wherein the conveying device is configured to receive and convey the laminated iron core, which falls from the retaining ring.

3. The apparatus for manufacturing the laminated iron core according to claim 1, wherein the holding portion includes:
multiple pressing portions that are arranged in a circumferential direction of the retaining ring and each have a radially outer surface capable of pressing the inner circumferential surface of the retaining ring; and
a changing unit that is configured to change positions of the radially outer surfaces of the pressing portions in a radial direction of the retaining ring.

4. The apparatus for manufacturing the laminated iron core according to claim 1, wherein the support portion includes a contact portion that is made of a plastic and is configured to contact the lower surface of the iron core pieces.

5. A back-pressure jig employed in an apparatus for manufacturing a laminated iron core, the apparatus including:
a die;
a punch that is configured to be lifted and lowered in an area above the die and to cooperate with the die to punch out iron core pieces from a magnetic steel sheet; and
a retaining ring that is disposed below the die and includes an inner circumferential surface configured to hold outer circumferential surfaces of the iron core pieces, wherein
the apparatus is configured to manufacture the laminated iron core by laminating the iron core pieces in the retaining ring,
the back-pressure jig is attached to an inner circumferential surface of the retaining ring and configured to support a lower surface of the iron core pieces so as to apply, to the iron core pieces, a back pressure that is an upward pressure when the punch pushes the iron core pieces downward, and
the back-pressure jig comprises:
a holding portion slidably held by the inner circumferential surface of the retaining ring; and
a support portion that is coupled to the holding portion and configured to support the lower surface of the iron core pieces.

6. The back-pressure jig according to claim 5, wherein the holding portion includes:
multiple pressing portions that are arranged in a circumferential direction of the retaining ring and each have a radially outer surface capable of pressing the inner circumferential surface of the retaining ring; and
a changing unit that is configured to change positions of the radially outer surfaces of the pressing portions in a radial direction of the retaining ring.

7. The back-pressure jig according to claim 5, wherein the support portion includes a contact portion that is made of a plastic and is configured to contact the lower surface of the iron core pieces.
